(19) United States
(12) Patent Application Publication
(10) Pub. No.: US 2008/0106260 A1
(43) Pub. Date: May 8, 2008

(54) Magnetic flux leakage system and method

(76) Inventor: John P. Rogers, Houston, TX (US)

Correspondence Address: LOREN G. HELMREICH, 5718 WESTHEIMER, SUITE 1800, HOUSTON, TX, 77057, US

(21) Appl. No.: 11/591,712

(22) Filed: Nov. 2, 2006

(51) Int. Cl. G01N 27/82

(52) U.S. Cl. 324/240

(57) ABSTRACT

A system for detecting defects in a string being pulled from the well includes an AC exciter (14) to induce eddy currents in the string, and a plurality of magnetic flux leakage detectors (16) circumferentially spaced about the string, each for detecting magnetic flux leakage indicative of a defect. Magnetic flux leakage signals may be output to computer (32) at the well site, or may be transmitted to another computer (36) remote from the well site. Data may be displayed as a function of depth of the string in the well, and signals may be calibrated to enhance reliability.

### FIELD OF THE INVENTION

The present invention relates to magnetic flux leakage techniques for determining defects in metal goods, and in particular in a drill pipe, tubing, casing, or sucker rod string of the type used in oil recovery operations while the string is pulled out of the well.

### BACKGROUND OF THE INVENTION

Magnetic flux leakage techniques have been used for decades to detect flaws and wall loss in a drill pipe, casing, production tubing and sucker rod string. Traditional methods use a DC flux technique to saturate the ferrous string, allowing flux to leak from the structure in areas where the apparent permeability of the material has changed due to a volume change in the material cross section. The flux that leaks into the area surrounding the string may be detected by use of a search coil, a Hall-effect element, a Giant Magneto-Resistive element or other sensor excited by the magnetic flux.

Cracks, splits, and small or smooth holes are difficult to detect using the above techniques due to the fact that, when there is not enough of a permeability change to cause flux leakage, the DC induced magnetic flux traveling around these defects can easily take another path around the defect, through the ferrous material, and not out of the string for detection. In other cases, as in a rod-wear induced failure, the split defect may be in the middle of a deep rod-wear track, resulting in a large magnetic flux leakage (MFL) signal which may tend to mask the relatively small signal from the split. It is desirable to identify these types of defects in strings commonly used in producing wells during work-over operations. Cracks that have progressed to the stage of a tubing leak are relatively easy to locate with hydraulic pressure testing techniques. Current MFL techniques are best at locating large flaws or wall loss areas that result in a large change in the tubular or rod metal volume.

To overcome the limitations of magnetic flux leakage techniques in finding cracks, splits, and holes, a method of eddy current inspection and ultrasonic testing methods have been proposed. This technique utilizes a single or differential AC coil(s) which detect flaws based upon impedance changes of the coil(s) and magnetic circuit caused by a discontinuity in the test article. This method works reasonably well for some applications, but requires sophisticated electronics to resolve the small changes in impedance and convert them to an image of the test article. These techniques are accordingly best suited to the controlled environment of the manufacturing plant, not the work-over rig-floor on a producing oil well.

The disadvantages of the prior art are overcome by the present invention, where an improved system and method are provided for detecting cracks, splits, holes and other defects in an oilfield string as the string is pulled from the well.

### SUMMARY OF THE INVENTION

A system for detecting defects in an oilfield string as a string is pulled from the well site includes an AC coil to excite a portion of the string with alternating current as the string is pulled from the well site, thereby inducing an eddy current. A plurality of magnetic flux leakage sensors may be used for detecting changes in magnetic flux leakage indicative of a defect, and outputting a magnetic flux leakage signal.

According to one embodiment of the method, defects in an oilfield tubular string are detected as the string is pulled from the well site by exposing a portion of the string to an alternating current based magnetic flux as the string is pulled from the well site, thereby inducing an eddy current. Defects in the string are detected utilizing a magnetic flux leakage sensor which has an output indicative of the defect.

These and further features and advantages of the present invention will become apparent from the following detailed description, when reference is made to the figures in the accompanying drawing.

### BRIEF DESCRIPTION OF THE DRAWING

FIG. 1 conceptually illustrates an AC exciter to saturate a portion of the string with alternating current, thereby inducing eddy currents, and a plurality of flux leakage detectors for detecting magnetic flux leakage indicative of a defect.

FIG. 2 is a block diagram illustrating suitable components between the detectors and the computer.

### DETAILED DESCRIPTION OF PREFERRED EMBODIMENTS

To reduce the complexity of the electronics and remove the necessity of using a differential eddy current probe or an ultrasonic system, an AC-MFL (Alternating Current Magnetic Flux Leakage) method is utilized for defect inspection on the surface of a string, such as a production tubing string or a sucker rod string. AC-MFL induces an eddy current that opposes the primary AC inspection field, in accordance with Lenz's laws. In cases where a discontinuity in the tubing material interferes with the flow of this compensating eddy current, a localized magnetic flux leakage field exists. The produced eddy currents are blocked by splits or abrupt defects in the metal crystal lattice of the string. These defects result in an AC leakage field about the defects, with a magnitude or signal envelope of the leakage field being detected with an amplitude modulation (AM) receiver or rectifier that captures the AC excitation envelope. The localized magnetic flux leakage field may be detected by a Hall-effect device or Giant Magneto-Resistive sensor with sufficient frequency response. The resulting leakage field may be superimposed in-phase on the AC excitation field.

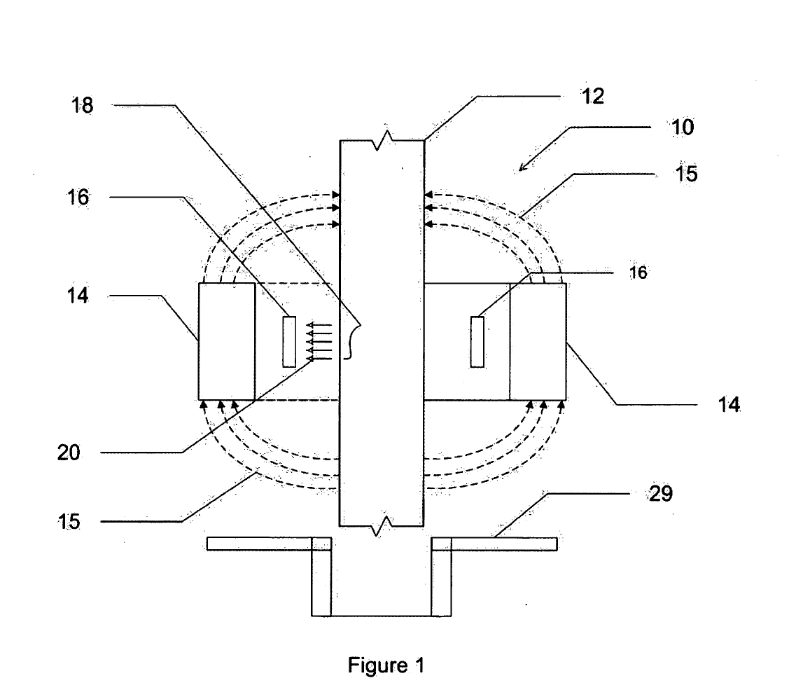

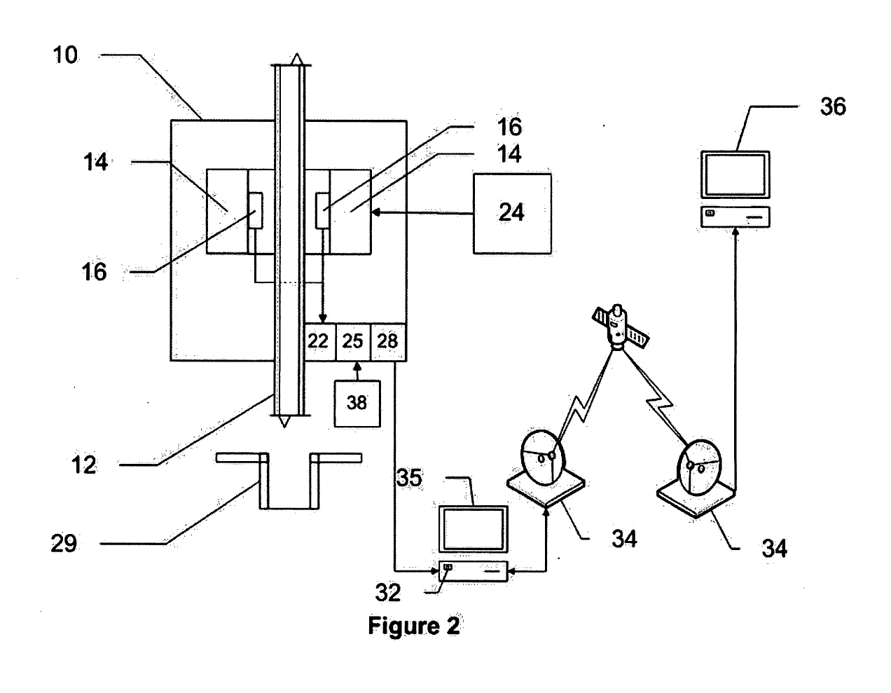

FIGS. 1 and 2 illustrate a suitable system 10 for detecting defects in a string 12. An AC exciter 14 preferably in the form of a coil encircles the string 12. AC power supply 24 may be used to generate an alternating current magnetic flux in the range of from approximately 1 to approximately 5 kHz for various sizes of tubing. The AC exciter thus produces an induced AC field 15. Defects may be detected by sensors 16, which may be Hall effect sensors or giant magneto-resistive (GMR) sensors. Defect 18 as depicted in FIG. 1 results in a change in a flux leakage field 20, which may be sensed by the detectors 16. Each sensor 16 may include an amplitude modulation receiver or rectifier circuit 22 that substantially captures the AC excitation envelope. The AC exciter 14 and the sensors 16 are located at the surface and above the wellhead 29, and measurements are taken as the string 12 is pulled from the well.

FIG. 2 illustrates the components between the sensors and the computer 32, which serves as a data collection and optionally a data transfer system. FIG. 2 thus depicts an AC power supply 24, with at least one of these components cooperating with the AC exciter 14 to form an alternating current magnetic flux leakage in the string 12 under consideration. Defects are detected by sensors 16, which include an AM receiver 22 that captures the AC excitation envelope. The signal envelope from each of the sensors 16 may be digitized at 25 and input into the computer 32 at the well site over a real time memory storage and telemetry system 28, and correlated as a function of the circumferential position of the sensors 16 about the string 12 and the depth of the string in the well being monitored as the string is pulled from the well. The computer 32 may output data to screen 34 so that the circumferential location and the size of the defect may be viewed by an operator. The computer 32 may also receive tally information from depth sensor 38, which monitors the passage of the string from the well, and provides a depth based trigger for the analog to digital converter 25, so that the depth of that portion of the string being examined will be known (or presumed) and that depth correlated with the defect signals. As one alternative, the sensors 38 may have a roller for engaging the cable extending from a draw-works to the top of the string, so that cable travel, which correlates to depth, is input to the computer. The signals which are correlated by depth and circumferential position can be displayed as a part of a 3D image of the test article and viewed via computer display 35 on location.

Computer 32 may also transmit the detected signals of our wireless telemetry system 34 to another computer 36, which may be provided at a field office remote from the well. This allows the data to be viewed by both the operator at the well and by a company representative at an office remote from the well. Computer 36 may also store data for later analysis, which may be particularly useful when analyzing similar defects in other wells, or when analyzing a string with a previous defect profile. Circumferential and axial defects can be detected with the same magnet and sensor configuration.

The present method allows cracks, splits, and holes to be detected and logged along the length of a joint of production tubing or sucker rod. A 3D image of the split may be developed 35 by disposing a plurality of sensors around the string and recording their response as the string is moved through the AC field as it is pulled from the well.

Signals from two or more sensors circumferentially spaced about the string as it is pulled from the well may be analyzed to determine the external position of one or more defects in the string at any depth. The system may be calibrated for each size (diameter) string and/or the cross-section of the string, so that the same signals may result in a defect detection in one string, but not be indicative of a defect for another size string. Calibrated signals may be displayed as a function of circumferential position of the plurality of detectors.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations, and modifications, including but not limited to those design alternatives specifically discussed herein, may be made in the practice of the invention without departing from its scope.

What is claimed is:

1. A system for detecting defects in a string as the string is pulled from a well, comprising:
an AC exciter to expose a portion of the string to an alternating current as the string is pulled from the well site, thereby inducing eddy currents in the string; and
a plurality of magnetic flux leakage detectors spaced circumferentially about the string each for detecting a magnetic flux leakage indicative of a defect, and outputting a magnetic flux leakage signal in response thereto.

2. A system as defined in claim 1, further comprising:
each detector including an amplitude modulation receiver that receives an AC envelope signal.

3. A system as defined in claim 1, wherein the plurality of magnetic flux leakage detectors includes one or more Hall effect devices.

4. A system as defined in claim 1, wherein the plurality of magnetic flux leakage detector includes one or more giant magneto-resistive sensors.

5. A system as defined in claim 1, further comprising:
a computer at the well for receiving the magnetic flux leakage signals from the plurality of detectors.

6. A system as defined in claim 5, wherein the computer outputs a visual display of a magnitude of the magnetic flux leakage signals as a function of the circumferential position of the detectors producing the signals.

7. A system as defined in claim 5, further comprising:
a transmission system for transmitting data from the computer at the well site to a computer remote from the well site.

8. A system as defined in claim 5, wherein a depth sensor outputs a depth signal to the computer indicative of the string depth when in the well.

9. A system as defined in claim 1, wherein the string is one of a production tubing string and a sucker rod string.

10. A system for detecting defects in one of a production tubing string and a sucker string as the string is pulled from a well, comprising:
an AC exciter to expose a portion of the string to alternating current as the string is pulled from the well site, thereby inducing eddy currents in the string;
a plurality of magnetic flux leakage detectors spaced circumferentially about the string each for detecting a magnetic flux leakage indicative of a defect, and outputting a magnetic flux leakage signal in response thereto; and
a computer at the well for receiving the magnetic flux leakage signals.

11. A system as defined in claim 10, wherein the plurality of magnetic flux leakage detectors include at least one of a Hall effect device and a giant magneto-resistive sensor.

12. A method of detecting defects in a string as a string is pulled from a well, comprising:
exposing a portion of the string to alternating current as it is pulled from the well, thereby inducing an eddy current in the portion of the string;
detecting magnetic flux leakage indicative of a defect; and
outputting a magnetic flux leakage signal in response to the detected leakage.

13. A method as defined in claim 12, further comprising:
sensing an AC envelope signal with an amplitude modulation receiver.

14. A method as defined in claim 12, further comprising:
calibrating the signals as a function of flaw type and the diameter of the tubing or rod test article.

15. A method as defined in claim 12, wherein a depth sensor outputs a depth signal to the computer indicative of the string depth when in the well.

16. A method as defined in claim 12, further comprising:
inputting the magnetic flux leakage signals to a computer at the well.

17. A method as defined in claim 16, further comprising:
transmitting magnetic flux leakage signals from the computer at the well to a computer remote from the well.

18. A method as defined in claim 12, further comprising:
calibrating signals from a plurality of sensors as a function of cross-section of the string.

19. A method as defined in claim 12, further comprising:
providing a 3D display of a magnitude of magnetic flux leakage signals from a plurality of detectors and a circumferential position of each detector producing a signal.

20. A method as defined in claim 12, wherein magnetic flux leakage is detected by at least one of a Hall effect device and a giant magneto-resistive sensor.
